(19) United States
(12) Patent Application Publication
(10) Pub. No.: US 2024/0349074 A1
(43) Pub. Date: Oct. 17, 2024

(54) INFORMATION DETERMINATION METHOD AND DEVICE, AND STORAGE MEDIUM

(71) Applicant: ZTE CORPORATION, Shenzhen (CN)

(72) Inventors: Ting MIAO, Shenzhen (CN); Weimin XING, Shenzhen (CN); Youxiong LU, Shenzhen (CN); Feng BI, Shenzhen (CN)

(21) Appl. No.: 18/683,055

(22) PCT Filed: Sep. 21, 2022
(86) PCT No.: PCT/CN2022/120318

§ 371 Date: Feb. 12, 2024

(30) Foreign Application Priority Data
Aug. 13, 2021 (CN) 202110931737.5

(51) Int. Cl. H04W 16/28; H04W 72/044; H04W 72/12

(52) U.S. Cl. CPC H04W 16/28; H04W 72/046; H04W 72/12

(57) ABSTRACT

Provided are an information determination method, a device, and a storage medium. The method includes: resource transmission direction configuration information and beam indication information, wherein the beam indication information is used for indicating a beam used by the first communication node in at least one time unit; and determining a forwarding state of a resource according to the resource transmission direction configuration information and the beam indication information, wherein the forwarding state comprises at least one of downlink (DL) forwarding, uplink (UL) forwarding, or no forwarding.

### TECHNICAL FIELD

The present application relates to the field of communications, for example, an information determination method, a device, and a storage medium.

### BACKGROUND

In a high-frequency scenario, a smart repeater may perform amplify-and-forward for uplink transmission and downlink transmission between a base station and a user equipment (UE) in a time-division manner by using a time-division duplexing (TDD) configuration and may determine, according to a forwarding state of a resource, whether data amplify-and-forward needs to be performed on a particular resource, so as to implement smart amplify-and-forward operations. However, how the smart repeater determines the forwarding state of the resource is an urgent technical problem to be solved.

### SUMMARY

Embodiments of the present application provide an information determination method, a device, and a storage medium so that a first communication node determines a forwarding state of a resource.

Embodiments of the present application provide an information determination method applied by a first communication node.

The method includes: acquiring at least one of resource transmission direction configuration information or resource forwarding state configuration information; and determining a forwarding state of a resource according to at least one of the resource transmission direction configuration information or the resource forwarding state configuration information, where the forwarding state includes at least one of downlink (DL) forwarding, uplink (UL) forwarding, or no forwarding.

Embodiments of the present application further provide an information determination method applied by a second communication node.

The method includes: configuring at least one of resource transmission direction configuration information or resource forwarding state configuration information; and sending at least one of the resource transmission direction configuration information or the resource forwarding state configuration information to a first communication node so that the first communication node determines a forwarding state of a resource according to at least one of the resource transmission direction configuration information or the resource forwarding state configuration information.

Embodiments of the present application provide an information determination apparatus applied to a first communication node. The apparatus includes a first acquisition module and a first determination module.

The first acquisition module is configured to acquire at least one of resource transmission direction configuration information or resource forwarding state configuration information. The first determination module is configured to determine a forwarding state of a resource according to at least one of the resource transmission direction configuration information or the resource forwarding state configuration information, where the forwarding state includes at least one of DL forwarding, UL forwarding, or no forwarding.

Embodiments of the present application provide an information determination apparatus applied to a second communication node. The apparatus includes a first configuration module and a first sender.

The first configuration module is configured to configure at least one of resource transmission direction configuration information or resource forwarding state configuration information. The first sender is configured to send at least one of the resource transmission direction configuration information or the resource forwarding state configuration information to a first communication node so that the first communication node determines a forwarding state of a resource according to at least one of the resource transmission direction configuration information or the resource forwarding state configuration information.

Embodiments of the present application provide a communication device. The device includes a communication module, a memory, and one or more processors. The communication module is configured to perform communication interaction between a first communication node, a second communication node, a third communication node, and a core network. The memory is configured to store one or more programs. When executed by the one or more processors, the one or more programs cause the one or more processors to perform the information determination method according to any one of the preceding embodiments.

Embodiments of the present application provide a storage medium, which is configured to store a computer program. The computer program, when executed by a processor, causes the processor to perform the information determination method according to any one of the preceding embodiments.

### BRIEF DESCRIPTION OF DRAWINGS

FIG. 1 is a schematic diagram of communications of a smart repeater according to the related art;

FIG. 2 is a flowchart of an information determination method according to an embodiment of the present application;

FIG. 3 is a flowchart of another information determination method according to an embodiment of the present application;

FIG. 4 is a schematic diagram of determination of a forwarding state of a resource according to an embodiment of the present application;

FIG. 5 is a schematic diagram of a configuration of resource forwarding state configuration information according to an embodiment of the present application;

FIG. 6 is a schematic diagram of another configuration of resource forwarding state configuration information according to an embodiment of the present application;

FIG. 7 is a schematic diagram of a mapping between a resource forwarding state combination index and time units according to an embodiment of the present application;

FIG. 8 is another schematic diagram of determination of a forwarding state of a resource according to an embodiment of the present application;

FIG. 9 is a block diagram of an information determination apparatus according to an embodiment of the present application;

FIG. 10 is a block diagram of another information determination apparatus according to an embodiment of the present application; and

FIG. 11 is a structure diagram of a communication device according to an embodiment of the present application.

### DETAILED DESCRIPTION

Embodiments of the present application are described hereinafter in conjunction with the drawings. The present application is described hereinafter in conjunction with the embodiments and the drawings. The examples listed hereinafter are intended to explain the present application and not to limit the scope of the present application.

Coverage is essential to the deployment of a cellular network. Generally, full network coverage may be provided by using different types of network nodes, such as a base station, an integrated access and backhaul (IAB) node, and a radio frequency (RF) repeater.

New Radio (NR) may use a higher frequency. Generally, a high-frequency channel has the disadvantages of a relatively large free propagation loss, being easily absorbed by oxygen, being greatly affected by rain fade, and the like, which severely affect coverage performance of a high-frequency communications system and aggravate a coverage challenge. In addition to the use of analog beamforming technology to enlarge a coverage range, the IAB node is introduced into the NR, where the IAB node is a relay node in the NR, access and backhaul are supported through the NR, a terminating node on a network side is a donor IAB, and all IAB nodes are connected to the donor IAB through one hop or multiple hops. The donor IAB is a next-generation NodeB (gNB) that supports IAB functions, and the gNB is a base station of the NR and generally includes one central unit (CU) and at least one distributed unit (DU). The IAB node is introduced so that NR cells can be flexibly and densely deployed without laying a large number of optical fibers, thereby saving network deployment costs and enlarging a network coverage range. An IAB node that supports some functions of a UE may be referred to as an IAB-MT, and the IAB-MT is wirelessly connected to a higher-level node (or referred to as a parent node) to implement backhaul. An IAB node that supports a function of the gNB-DU at the same time is referred to as an IAB-DU, which may serve a common UE and an IAB node (or referred to as a child node). The IAB node is a regenerative type of relay. Each data packet forwarded by the IAB node is correctly decoded and re-encoded by the IAB node to be transmitted to a next-hop node or a terminal.

A repeater has been used in the deployment of the 2nd generation mobile communication technology (2G), 3G, and 4G, which is a device for receiving, amplifying, and transmitting data in a downlink direction (from the base station to the terminal) and an uplink direction (from the terminal to the base station). The repeater can supplement network coverage and enhance a coverage capability of a network and is a simplest and most cost-effective method for improving a network coverage rate. The repeater has the advantages of a low cost, easy deployment, and no increase in delay and the disadvantage of simultaneously amplifying a useful signal and noise, which may increase interference (pollution) in a system. The RF repeater is a non-regenerative type of relay, which simply amplifies and sends all of received data. The RF repeater is generally a full-duplex node, which is not distinguished between uplink and downlink from the perspective of sending or receiving.

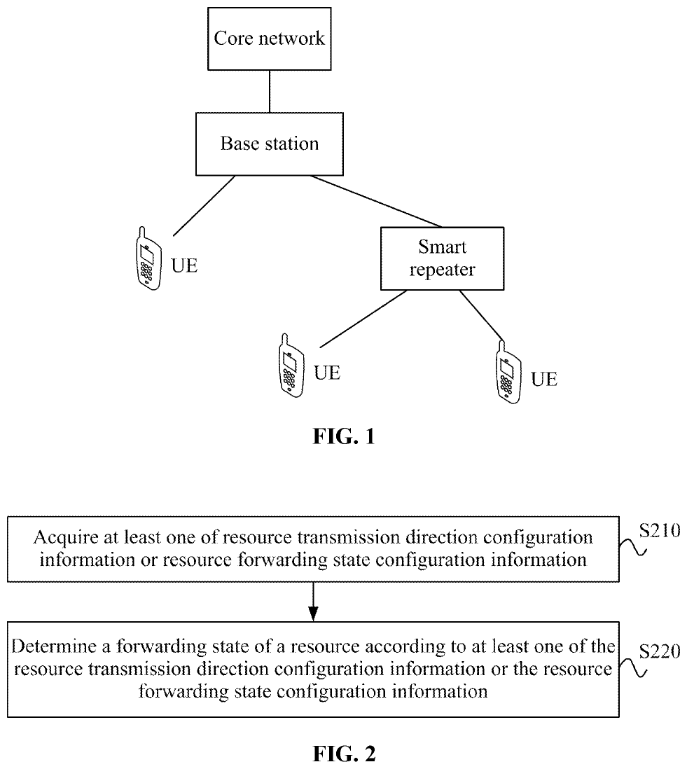

In NR deployment, a TDD manner may be used so that bidirectional amplify-and-forward may not be required at the same time, which can reduce pollution of a common repeater. The analog beamforming technology is used for performing transmission for a single user, which can extend coverage, especially at a high frequency. However, a common repeater that is not known to a network may fail to obtain a beam gain. Therefore, a smart repeater between the common repeater and the IAB node is a better choice. FIG. 1 is a schematic diagram of communications of a smart repeater according to the related art. On downlink, the smart repeater receives data from the base station and amplifies and sends the data to the terminal (UE). On uplink, the smart repeater receives data from the UE and amplifies and sends the data to the base station. A process of the smart repeater receiving, amplifying, and sending data transmitted between the base station and the UE is referred to as amplify-and-forward. The base station may provide the smart repeater with side control information, such as a TDD configuration (that is, division of uplink and downlink transmission directions in time domain), a forwarding state of a resource, and a beam configuration. The smart repeater may perform amplify-and-forward for uplink transmission and downlink transmission between the base station and the UE in a time-division manner by using the TDD configuration and may determine, according to the forwarding state of the resource, whether data amplify-and-forward needs to be performed on a particular resource, so as to implement smart amplify-and-forward operations, which can not only save power but also reduce interference with other radio links. However, how the smart repeater determines the forwarding state of the resource is an urgent technical problem to be solved.

In view of this, embodiments of the present application provide an information determination method so that a first communication node determines a forwarding state of a resource.

In an embodiment, FIG. 2 is a flowchart of an information determination method according to an embodiment of the present application. This embodiment may be implemented by an information determination device. The information determination device may be the first communication node. For example, the first communication node may be a smart repeater. As shown in FIG. 2, this embodiment includes S210 and S220.

In S210, at least one of resource transmission direction configuration information or resource forwarding state configuration information is acquired.

The resource transmission direction configuration information refers to information for configuring a transmission direction of the resource. In an embodiment, the transmission direction of the resource includes at least one of downlink (DL), uplink (UL), or flexible (F). The resource forwarding state configuration information refers to information for configuring the forwarding state of the resource. In an embodiment, the resource transmission direction configuration information is determined in one of the following manners: a configuration of a second communication node; a configuration of a network management device; or a predefinition. The second communication node includes at least one of a gNB, an evolved NodeB (eNB), a donor IAB node, an IAB node, a relay node, a transmission reception point (TRP), an access point (AP), a central unit (CU), a distributed unit (DU), or a mobile terminal (MT). The network management device may be understood as a network manager. For example, the network management device may be an operations, administration, and maintenance (OAM) system. When the resource transmission direction configuration information is configured by the network management device, a base station and the smart repeater may acquire the resource transmission direction configuration information from the network management device.

In S220, the forwarding state of the resource is determined according to at least one of the resource transmission direction configuration information or the resource forwarding state configuration information.

In this embodiment, the first communication node acquires the resource transmission direction configuration information (that is, configuration information of the transmission direction of the resource) and determines, according to the transmission direction of the resource, whether to perform amplify-and-forward on data on the resource and a forwarding direction, that is, determines the forwarding state of the resource, thereby determining the forwarding state of the resource. The forwarding state includes at least one of DL forwarding, UL forwarding, or no forwarding. In this embodiment, the DL forwarding refers to that the first communication node performs amplify-and-forward on data sent by the second communication node to a third communication node, the UL forwarding refers to that the first communication node performs amplify-and-forward on data sent by the third communication node to the second communication node, and no forwarding refers to that the first communication node performs no forwarding operation. In this embodiment, for a resource whose forwarding state is the DL forwarding, the first communication node performs amplify-and-forward on data sent by the second communication node to the third communication node; for a resource whose forwarding state is the UL forwarding, the first communication node performs amplify-and-forward on data sent by the third communication node to the second communication node; and for a resource whose forwarding state is no forwarding, the first communication node performs no forwarding operation. In this embodiment, if the transmission direction of the resource is DL, that is, the resource is a DL resource, the first communication node performs amplify-and-forward on data sent by the second communication node to the third communication node; if the transmission direction of the resource is UL, that is, the resource is an UL resource, the first communication node performs amplify-and-forward on data sent by the third communication node to the second communication node; and if the transmission direction of the resource is F, that is, the resource is an F resource, the first communication node does not perform amplify-and-forward. In an embodiment, the third communication node includes one of a UE, a MT, or a terminal part of the relay node.

In an embodiment, the resource transmission direction configuration information includes at least one of first resource transmission direction configuration information or second resource transmission direction configuration information.

In an embodiment, the first resource transmission direction configuration information includes at least one of: third resource transmission direction configuration information; or third resource transmission direction configuration information and fourth resource transmission direction configuration information.

The third resource transmission direction configuration information is used for indicating a transmission direction of each time unit in a configuration period or a transmission direction of a symbol in each time unit in a configuration period. The transmission direction is one of DL, UL, or F.

In this embodiment, the second communication node may send the third resource transmission direction configuration information to the first communication node to periodically indicate the transmission direction of the resource.

The third resource transmission direction configuration information includes at least one of a subcarrier spacing, the configuration period, or transmission direction information of a time domain resource in the configuration period. The subcarrier spacing is used as reference for a resource transmission direction configuration, that is, a time unit and a symbol in the resource transmission direction configuration are both determined by the subcarrier spacing.

The third resource transmission direction configuration information includes at least one configuration period and transmission direction information of a time domain resource in the at least one configuration period. In the case where the third resource transmission direction configuration information includes multiple configuration periods, the multiple configuration periods constitute a large configuration period in sequence, and the transmission direction of the resource is periodically indicated according to the large configuration period.

The transmission direction information of the time domain resource in the configuration period may indicate the direction of the symbol in each time unit in the configuration period. For example, in a time unit 1, a first group of (or first x1) symbols is DL, and a second group of (or last y1) symbols is UL; in a time unit 2, a first group of (or first x2) symbols is UL, and a second group of (or last y2) symbols is DL. x1, y1, x2, and y2 are non-negative integers, a sum of x1 and y1 is not greater than a total number of symbols included in one time unit, and a sum of x2 and y2 is not greater than the total number of symbols included in one time unit. A transmission direction of a symbol not indicated may be F by default.

The transmission direction information of the time domain resource in the configuration period may indicate a time unit format index used by each time unit in the configuration period. A time unit format defines a direction of a symbol in one time unit, at least one time unit format may be predefined, and each time unit format corresponds to one time unit format index.

The transmission direction information of the time domain resource in the configuration period may indicate a direction of a group of time resources in the configuration period. The group of time resources includes a group of time units or a group of symbols. For example, in one configuration period, a first group of (or first x3) time units is DL, a second group of (or last y3) time units is UL, first x4 symbols in a time unit after the first group of time units are DL, last y4 symbols in a time unit before the second group of time units are UL, and so on. x3, y3, x4, and y4 are non-negative integers, a sum of x3 and y3 is not greater than a total number of time units included in one configuration period, and each of x3 and y4 is not greater than the total number of symbols included in one time unit or the total number of symbols minus one. The transmission direction of the symbol not indicated may be F by default.

The fourth resource transmission direction configuration information may cover or overwrite a transmission direction provided in the third resource transmission direction configuration information. For example, a transmission direction provided in the fourth resource transmission direction configuration information may cover any transmission direction of the resource or may cover only the F transmission direction of the resource indicated in the third resource transmission direction configuration information.

The fourth resource transmission direction configuration information indicates a transmission direction of a symbol in at least one time unit in the configuration period, and the fourth resource transmission direction configuration information includes at least one of a time unit index or a transmission direction of a symbol in a time unit.

The time unit index is a number of a time unit in the configuration period provided in the third resource transmission direction configuration information or a number of a time unit in a fixed time length. For example, with a slot as an example of the time unit, in the case where a fixed time is 10 milliseconds and the subcarrier spacing is 480 kHz, the number of time units is 320, and time unit indexes (that is, slot indexes) are 0 to 319.

The transmission direction of the symbol in the time unit may include one of the following: all symbols in the time unit are DL; all symbols in the time unit are UL; or in the time unit, a first group of symbols is DL and a second group of symbols is UL.

In the time unit indicated in the fourth resource transmission direction configuration information, the direction of the symbol not indicated is F by default.

The second resource transmission direction configuration information includes fifth resource transmission direction configuration information and sixth resource transmission direction configuration information.

The fifth resource transmission direction configuration information includes at least a resource transmission direction combination list, the resource transmission direction combination list includes at least one resource transmission direction combination, and one resource transmission direction combination corresponds to one resource transmission direction combination index. The sixth resource transmission direction configuration information is used for indicating one resource transmission direction combination index in the resource transmission direction combination list.

The resource transmission direction combination index is used for indicating a transmission direction of a resource in at least one time unit.

An element in the resource transmission direction combination is used for indicating a transmission direction of a resource in a corresponding time unit. For example, the element is the time unit format index, the time unit format defines the direction of the symbol in one time unit, at least one time unit format may be predefined, and each time unit format corresponds to one time unit format index.

The first resource transmission direction configuration information may be information for statically or periodically configuring the transmission direction of the resource. The second resource transmission direction configuration information may be information for dynamically configuring the transmission direction of the resource.

In an embodiment, for a time resource, a transmission direction provided in the second resource transmission direction configuration information covers any transmission direction provided in the first resource transmission direction configuration information; or for a time resource, a transmission direction provided in the second resource transmission direction configuration information covers an F transmission direction provided in the first resource transmission direction configuration information. In an embodiment, for the time resource, the transmission direction provided in the second resource transmission direction configuration information may cover any transmission direction provided in the first resource transmission direction configuration information. For example, for the time resource, if the transmission direction provided in the first resource transmission direction configuration information is DL and the transmission direction provided in the second resource transmission direction configuration information is UL or F, DL is correspondingly overwritten to UL or F; if the transmission direction provided in the first resource transmission direction configuration information is UL and the transmission direction provided in the second resource transmission direction configuration information is DL or F, UL is correspondingly overwritten to DL or F; if the transmission direction provided in the first resource transmission direction configuration information is F and the transmission direction provided in the second resource transmission direction configuration information is DL or UL, F is correspondingly overwritten to DL or UL. In an embodiment, for the time resource, the transmission direction provided in the second resource transmission direction configuration information may cover the F transmission direction provided in the first resource transmission direction configuration information. For example, for the time resource, if the transmission direction provided in the first resource transmission direction configuration information is F and the transmission direction provided in the second resource transmission direction configuration information is DL or UL, F is correspondingly overwritten to DL or UL.

In an embodiment, for the time resource, in the case where at least two pieces of second resource transmission direction configuration information provide transmission directions of the time resource, a transmission direction of the time resource is determined in one of the manners below.

For the time resource, the at least two pieces of second resource transmission direction configuration information provide the same transmission direction; for the time resource, a transmission direction provided in latest second resource transmission direction configuration information prevails; or for the time resource, a transmission direction provided in earliest second resource transmission direction configuration information prevails. In this embodiment, for the same time resource, each piece of second resource transmission direction configuration information configured by the second communication node provides the same transmission direction. For the same time resource, in the case where multiple pieces of second resource transmission direction configuration information configured by the second communication node provide inconsistent transmission directions, the transmission direction provided in the latest second resource transmission direction configuration information may prevail, that is, the transmission direction provided in the latest second resource transmission direction configuration information may overwrite a transmission direction provided in previous second resource transmission direction configuration information. For the same time resource, in the case where multiple pieces of second resource transmission direction configuration information configured by the second communication node provide inconsistent transmission directions, the transmission direction provided in the earliest second resource transmission direction configuration information may prevail, that is, the transmission direction provided in the earliest second resource transmission direction configuration information cannot be overwritten by a transmission direction provided in later second resource transmission direction configuration information.

In an embodiment, the first resource transmission direction configuration information may be carried in at least one of the following signaling: radio resource control (RRC); F1 application protocol (AP); or medium access control-control element (MAC CE); and the second resource transmission direction configuration information is carried in at least one of the following signaling: RRC; downlink control information (DCI); or MAC CE. In this embodiment, different information in the first resource transmission direction configuration information may be carried in different signaling. In this embodiment, different information in the second resource transmission direction configuration information may be carried in different signaling. In this embodiment, when a newly defined interface is used between the first communication node and the second communication node, signaling carrying the first resource transmission direction configuration information and the second resource transmission direction configuration information may be transmission signaling on the newly defined interface, which is not limited herein.

In an embodiment, that the forwarding state of the resource is determined according to the resource transmission direction configuration information includes one of the following: a forwarding state of a resource whose transmission direction is DL is the DL forwarding, a forwarding state of a resource whose transmission direction is UL is the UL forwarding, and a forwarding state of a resource whose transmission direction is F is no forwarding; a forwarding state of a resource whose transmission direction is DL is the DL forwarding, a forwarding state of a resource whose transmission direction is UL is the UL forwarding, in the case where the first communication node is scheduled to receive on a resource whose transmission direction is F, a forwarding state of the resource whose transmission direction is F is the DL forwarding, in the case where the first communication node is scheduled to send on the resource whose transmission direction is F, the forwarding state of the resource whose transmission direction is F is the UL forwarding, and in the case where the first communication node is not scheduled on the resource whose transmission direction is F, the forwarding state of the resource whose transmission direction is F is no forwarding; a forwarding state of a resource whose transmission direction is DL is the DL forwarding, a forwarding state of a resource whose transmission direction is UL is the UL forwarding, in the case where the first communication node is indicated a transmit beam used on a resource whose transmission direction is F, a forwarding state of the resource whose transmission direction is F is the DL forwarding, in the case where the first communication node is indicated a receive beam used on the resource whose transmission direction is F, the forwarding state of the resource whose transmission direction is F is the UL forwarding, and in the case where a beam that the first communication node is indicated for use on the resource whose transmission direction is F is a null (that is, no beam is used) or the first communication node is not indicated a beam used on the resource whose transmission direction is F, the forwarding state of the resource whose transmission direction is F is no forwarding; or, a forwarding state of a resource whose transmission direction is DL is the DL forwarding, a forwarding state of a resource whose transmission direction is UL is the UL forwarding, in the case where the first communication node is scheduled to receive or indicated a transmit beam used on a resource whose transmission direction is F, a forwarding state of the resource whose transmission direction is F is the DL forwarding, in the case where the first communication node is scheduled to send or indicated a receive beam used on the resource whose transmission direction is F, the forwarding state of the resource whose transmission direction is F is the UL forwarding, and in the case where the first communication node is not scheduled and a beam that the first communication node is indicated for use on the resource whose transmission direction is F is null or the first communication node is not indicated a beam used on the resource whose transmission direction is F, the forwarding state of the resource whose transmission direction is F is no forwarding. In this embodiment, that the first communication node is scheduled to receive on the resource whose transmission direction is F refers to that the first communication node receives information from the second communication node on the resource whose transmission direction is F; that the first communication node is scheduled to send on the resource whose transmission direction is F refers to that the first communication node sends information to the second communication node on the resource whose transmission direction is F; the transmit beam or the receive beam that the first communication node is indicated to use on the resource whose transmission direction is F refers to a beam used by the first communication node on a link between the first communication node and the third communication node. For example, the transmit beam may be a beam used by the first communication node for sending to the third communication node, and the receive beam may be a beam used by the first communication node for receiving from the third communication node.

In an embodiment, that the forwarding state of the resource is determined according to the resource transmission direction configuration information includes one of the following: the forwarding state of the DL resource is the DL forwarding, the forwarding state of the UL resource is the UL forwarding, or the forwarding state of the F resource is no forwarding; or the forwarding state of the DL resource is the DL forwarding, the forwarding state of the UL resource is the UL forwarding, the forwarding state of the F resource is no forwarding by default, and the forwarding state of the F resource is determined according to a transmission direction of the F resource implicitly determined by the first communication node.

That the forwarding state of the F resource is determined according to the transmission direction of the F resource implicitly determined by the first communication node includes the following: if the transmission direction of the F resource is implicitly determined to be DL, the forwarding state of the F resource is the DL forwarding; and if the transmission direction of the F resource is implicitly determined to be UL, the forwarding state of the F resource is the UL forwarding.

The methods for implicitly determining the transmission direction of the F resource includes, but is not limited to, determining the transmission direction of the F resource according to scheduling of the first communication node by the second communication node; and determining the transmission direction of the F resource according to a beam configured by the second communication node for use of the first communication node. The beam configured for use of the first communication node is a beam used on the link between the first communication node and the third communication node.

The forwarding state of the F resource determined according to the transmission direction of the F resource implicitly determined by the first communication node may cover or overwrite the default forwarding state (that is, no forwarding) of the F resource. That is, the forwarding state of the F resource determined according to the transmission direction of the F resource implicitly determined by the first communication node has a high priority.

In an embodiment, the first communication node receives the resource forwarding state configuration information sent by the second communication node and determines, according to the resource forwarding state configuration information, whether to perform amplify-and-forward on the resource and the forwarding direction, that is, determines the forwarding state of the resource according to the resource forwarding state configuration information. In this embodiment, the forwarding state of the resource in the time unit may be periodically or semi-statically configured. Alternatively, a resource forwarding state combination list may be configured, and then a resource forwarding state combination in the resource forwarding state combination list is indicated, where the resource forwarding state combination indicates a forwarding state of a resource in at least one time unit.

In an embodiment, the resource forwarding state configuration information indicates the forwarding state of the resource in at least one time unit in the configuration period.

In an embodiment, the resource forwarding state configuration information includes at least one of the configuration period, a set of time units with the DL forwarding in the configuration period, a set of time units with the UL forwarding in the configuration period, or a set of time units with no forwarding in the configuration period. The time units in the set of time units may be consecutive or discrete.

In an embodiment, the resource forwarding state configuration information includes the configuration period and two of {the set of time units with the DL forwarding in the configuration period, the set of time units with the UL forwarding in the configuration period, the set of time units with no forwarding in the configuration period}. A forwarding state of a time unit not configured is a default state, where the default state is one of the DL forwarding, the UL forwarding, or no forwarding. For example, the resource forwarding state configuration information includes the configuration period, the set of time units with the DL forwarding in the configuration period, and the set of time units with the UL forwarding in the configuration period. The forwarding state of the time unit not configured is no forwarding by default. For example, the configuration period is 10 milliseconds and includes 10 time units, the first four time units have the DL forwarding, and the last four time units have the UL forwarding. The forwarding state of the time unit not configured (that is, two time units in the middle) is no forwarding.

In an embodiment, the resource forwarding state configuration information periodically or semi-statically indicates the forwarding state of the resource in at least one time unit.

In an embodiment, the resource forwarding state configuration information includes at least one of: the resource forwarding state combination; the configuration period; at least one parameter pair composed of one time unit and one resource forwarding state; or a forwarding state bitmap; where the forwarding state bitmap is used for indicating a time unit corresponding to each resource forwarding state in the resource forwarding state combination in the configuration period.

In an embodiment, one resource forwarding state is bound to one resource forwarding state index, that is, a mapping relationship exists between the resource forwarding state index and the resource forwarding state. The mapping relationship may be predefined or configured by the second communication node and sent to the first communication node. The one resource forwarding state may be applied to one time unit, that is, one resource forwarding state is the forwarding state of the resource in one time unit.

In an embodiment, the resource forwarding state combination is a combination composed of resource forwarding state indexes, or the resource forwarding state combination includes at least one time unit and a corresponding forwarding state, or the resource forwarding state combination includes at least a symbol in at least one time unit and a corresponding forwarding state. For example, the resource forwarding state combination is the combination composed of resource forwarding state indexes. For example, the resource forwarding state combination is {resource forwarding state 2, resource forwarding state 3, resource forwarding state 1, resource forwarding state 5}, where one element in the resource forwarding state combination corresponds to the forwarding state of one time unit. Alternatively, the resource forwarding state combination includes at least one time unit and the corresponding forwarding state or includes the symbol in at least one time unit and the corresponding forwarding state. For example, the resource forwarding state combination is {DL forwarding, UL forwarding, no forwarding, UL forwarding, DL forwarding}, where one element in the resource forwarding state combination corresponds to the forwarding state of one time unit. As another example, the resource forwarding state combination is {(a symbol set a1 in the time unit has DL forwarding, a symbol set a2 in the time unit has UL forwarding), (a symbol set b1 in the time unit has DL forwarding), (a symbol set c1 in the time unit has DL forwarding)}, where one element (that is, (*)) corresponds to the forwarding state of the symbol in one time unit, the symbol set includes at least one symbol, and symbols in the symbol set may be consecutive or discrete. The forwarding state of the symbol not indicated in the time unit is no forwarding.

In an embodiment, the parameter pair composed of one time unit and one resource forwarding state may be a parameter pair composed of the time unit index and the resource forwarding state index. For example, the parameter pair is {time unit 1, resource forwarding state 1}, {time unit 2, resource forwarding state 3}, and {time unit 3, resource forwarding state 2}. In an embodiment, the parameter pair composed of one time unit and one resource forwarding state may be a parameter pair composed of the time unit index and the resource forwarding state. For example, the parameter pair is {time unit 1, DL forwarding}, {time unit 2, UL forwarding}, and {time unit 3, no forwarding}.

In an embodiment, the mapping relationship between the forwarding state of the resource in the time unit and the resource forwarding state index is determined in a configuration or protocol predefinition manner. The mapping relationship between the forwarding state of the resource in the time unit and the resource forwarding state index may be configured by the base station or may be determined in the protocol predefinition manner. For example, Table 1 is a table of a mapping relationship between the forwarding state of the symbol in the time unit and the resource forwarding state index according to an embodiment of the present application. As shown in Table 1, in the case where the resource forwarding state index has a value of 0, it indicates that forwarding states of all symbols in the time unit are no forwarding, that is, the smart repeater does not need to perform amplify-and-forward in the time unit; in the case where the resource forwarding state index has a value of 1, it indicates that the forwarding state of a DL symbol in the time unit is the DL forwarding, and the forwarding state of an UL symbol and the forwarding state of an F symbol are no forwarding, that is, the smart repeater needs to perform data amplify-and-forward on the DL symbol and does not need amplify-and-forward on the UL symbol and the F symbol in the time unit. Meanings of other values are similar.

TABLE 1
Mapping relationship between the forwarding state of the symbol
in the time unit and the resource forwarding state index

| Resource | |
|---|---|
| Forwarding | |
| State Index | Forwarding State of the Symbol in the Time Unit |
| 0 | Forwarding states of all symbols are no forwarding. |
| 1 | The forwarding state of the DL symbol is DL |
| | forwarding, and the forwarding state of the UL symbol |
| | and the forwarding state of the F symbol are no |
| | forwarding. |
| 2 | The forwarding state of the UL symbol is UL |
| | forwarding, and the forwarding state of the DL symbol |
| | and the forwarding state of the F symbol are no |
| | forwarding. |
| 3 | The forwarding state of the DL symbol is DL |
| | forwarding, the forwarding state of the UL symbol is UL |
| | forwarding, and the forwarding state of the F symbol is |
| | no forwarding. |
| 4 | The forwarding state of the F symbol is DL forwarding, |
| | and the forwarding state of the DL symbol and the |
| | forwarding state of the UL symbol are no forwarding. |
| 5 | The forwarding state of the DL symbol is DL |
| | forwarding, the forwarding state of the F symbol is DL |
| | forwarding, and the forwarding state of the UL symbol |
| | is no forwarding. |
| 6 | The forwarding state of the UL symbol is UL |
| | forwarding, the forwarding state of the F symbol is UL |
| | forwarding, and the forwarding state of the DL symbol |
| | is no forwarding. |
| 7 | The forwarding state of the F symbol is UL forwarding, |
| | and the forwarding state of the DL symbol and the |
| | forwarding state of the UL symbol are no forwarding. |
| . . . | . . . |
| K | . . . |

In an embodiment, the second communication node may explicitly or implicitly indicate the transmission direction of the F resource. In an embodiment, the transmission direction of the F resource is determined in one of the following manners: according to a configuration instruction of the transmission direction of the F resource that is sent by the second communication node; according to the scheduling of the first communication node by the second communication node; or according to the beam that the second communication node indicates the first communication node to use. In an embodiment, the forwarding state of the F resource is determined according to the determined transmission direction of the F resource. For example, if the transmission direction of the F resource is determined to be DL, the forwarding state of the F resource is the DL forwarding; if the transmission direction of the F resource is determined to be UL, the forwarding state of the F resource is the UL forwarding; and if the transmission direction of the F resource is still determined to be F, the forwarding state of the F resource is no forwarding. In an embodiment, that the transmission direction of the F resource is determined according to the beam that the second communication node indicates the first communication node to use is described. For example, if the second communication node indicates the first communication node to use the transmit beam on the F resource, the transmission direction of the F resource is DL; if the second communication node indicates the first communication node to use the receive beam on the F resource, the transmission direction of the F resource is UL. The beam used by the first communication node refers to the beam used by the first communication node on the link between the first communication node and the third communication node. The third communication node may be the terminal or another type of communication node, which is not limited. In an embodiment, that the transmission direction of the F resource is determined according to the scheduling of the first communication node by the second communication node is described. For example, if the second communication node configures and schedules the first communication node to monitor a downlink control channel or receive downlink data on the F resource, the transmission direction of the F resource is DL; if the second communication node schedules the first communication node to send information to the second communication node on the F resource, the transmission direction of the F resource is UL. In an embodiment, that the transmission direction of the F resource is determined according to the configuration instruction of the transmission direction of the F resource that is sent by the second communication node is described. For example, if the second communication node sends side control information to the first communication node on the F resource, the transmission direction of the F resource is DL; if the first communication node feeds back whether the side control information is successfully received to the second communication node on the F resource, the transmission direction of the F resource is UL.

In an embodiment, the time unit includes one of a radio frame, a half-frame, a subframe, the slot, a mini slot, the symbol, a slot group, or a symbol group. In an embodiment, the slot group includes multiple slots; and the symbol group includes multiple symbols.

In an embodiment, the resource forwarding state configuration information includes first resource forwarding state configuration information and second resource forwarding state configuration information; where the first resource forwarding state configuration information includes at least the resource forwarding state combination list, the resource forwarding state combination list includes at least one resource forwarding state combination, and one resource forwarding state combination corresponds to one resource forwarding state combination index; and the second resource forwarding state configuration information is used for indicating one resource forwarding state combination index in the resource forwarding state combination list. For example, the first resource forwarding state configuration information may be carried in one of the following signaling: RRC; F1 AP; or MAC CE; and the second resource forwarding state configuration information may be carried in one of the following signaling: RRC; DCI; or MAC CE. In an embodiment, the resource forwarding state combination list may be configured through RRC, and one resource forwarding state combination index in the resource forwarding state combination list is indicated through DCI.

In an embodiment, the resource forwarding state combination index is used for indicating a forwarding state of the resource in at least one time unit.

In an embodiment, an element in the resource forwarding state combination is used for indicating a forwarding state of a resource in a corresponding time unit.

In an embodiment, in a time unit where no resource forwarding state is provided, the forwarding state of the resource is determined according to a resource transmission direction in the time unit or determined according to a beam indicated for use in the time unit. In this embodiment, if the second communication node indicates the first communication node the transmit beam used on the resource in the time unit, the forwarding state of the resource on which the transmit beam is indicated for use and in the time unit is the DL forwarding; if the second communication node indicates the first communication node the receive beam used on the resource in the time unit, the forwarding state of the resource on which the receive beam is indicated for use and in the time unit is the UL forwarding; and if the beam that the second communication node indicates the first communication node to use on the resource in the time unit is null (that is, no beam is indicated) or no beam is indicated for use on the resource in the time unit, the state of the resource on which the null beam is indicated for use or no beam is indicated for use and in the time unit is no forwarding. The beam refers to the beam used by the first communication node on the link between the first communication node and the third communication node or the beam used for sending to the third communication node or receiving from the third communication node.

In an embodiment, a starting time unit where the second resource forwarding state configuration information takes effect includes one of: a time unit where the second resource forwarding state configuration information is detected or an N-th time unit after a time unit where the second resource forwarding state configuration information is detected, where N is a positive integer greater than or equal to 1.

In an embodiment, the information determination method applied by the first communication node further includes: acquiring beam indication information, where the beam indication information is used for indicating a beam used by the first communication node in at least one time unit. In this embodiment, the first communication node receives the beam indication information from the second communication node and determines the forwarding state of the resource according to the beam indication information.

In an embodiment, for a time unit, the beam indication information includes at least one of: a beam used on a DL resource, a beam used on an UL resource, a transmit beam or a receive beam used on an F resource, a transmit beam used on a first group of resources, a receive beam used on a second group of resources, or a null beam used. In an embodiment, the beam indication information may include a first parameter or a second parameter, where the first parameter includes at least one of the beam used on the DL resource, the beam used on the UL resource, or the beam used on the F resource. The second parameter includes the null beam used. In an embodiment, one or more beams may be used on the DL resource. Similarly, one or more beams may be used on the UL resource; and one or more beams may be used on the F resource.

In an embodiment, the first group of resources and the second group of resources are a group of time resources in the time unit and may be a group of slots or a group of symbols. The first group of resources is orthogonal to the second group of resources in time domain.

In an embodiment, the information determination method applied by the first communication node further includes determining the forwarding state of the resource according to the beam indication information, which includes one of the following: in the case where a transmit beam used on a resource in a time unit is indicated or a beam used on a DL resource in a time unit is indicated, a forwarding state of the resource is the DL forwarding; in the case where a receive beam used on the resource in the time unit is indicated or a beam used on an UL resource in the time unit is indicated, a forwarding state of the resource is the UL forwarding; or in the case where a beam indicated for use on a resource in the time unit is null or no beam is indicated for use on a resource in the time unit, a forwarding state of the resource is no forwarding.

In this embodiment, the forwarding state of the resource determined according to the beam indication information may cover the forwarding state of the resource determined according to the resource transmission direction configuration information.

In an embodiment, the forwarding state of the F resource is determined in at least one of the following manners: the forwarding state of the F resource is no forwarding by default; the forwarding state of the F resource is determined according to the beam indication information; or the forwarding state of the F resource is determined according to scheduling of the first communication node by the second communication node on the F resource. In an embodiment, in the case where the forwarding state of the F resource is determined according to the scheduling of the first communication node by the second communication node on the F resource, if the first communication node is scheduled to receive on the resource whose transmission direction is F, the forwarding state of the F resource is the DL forwarding; if the first communication node is scheduled to send on the resource whose transmission direction is F, the forwarding state of the F resource is the UL forwarding; if the first communication node is not scheduled on the resource whose transmission direction is F, the forwarding state of the F resource is no forwarding. Being scheduled to receive refers to that the first communication node receives information from the second communication node; and being scheduled to send refers to that the first communication node sends information to the second communication node. In an embodiment, in the case where the forwarding state of the F resource is determined according to the beam indication information, if the first communication node is indicated the transmit beam used on the resource whose transmission direction is F, the forwarding state of the resource is the DL forwarding; if the first communication node is indicated the receive beam used on the resource whose transmission direction is F, the forwarding state of the resource is the UL forwarding; and if the beam indicated to the first communication node is null or the first communication node is not indicated a beam used on the resource whose transmission direction is F, the forwarding state of the resource is no forwarding. The beam refers to the beam used by the first communication node on the link between the first communication node and the third communication node or the beam used for sending to the third communication node or receiving from the third communication node.

In an embodiment, the forwarding state of the F resource determined according to the beam indication information has priority over the default forwarding state (that is, no forwarding) of the F resource, that is, the forwarding state of the F resource determined according to the beam indication information may cover or overwrite the default forwarding state of the F resource.

In an embodiment, the forwarding state of the F resource determined according to the scheduling of the first communication node by the second communication node on the F resource has priority over the default forwarding state (that is, no forwarding) of the F resource, that is, the forwarding state of the F resource determined according to the scheduling of the first communication node by the second communication node on the F resource may cover or overwrite the default forwarding state of the F resource.

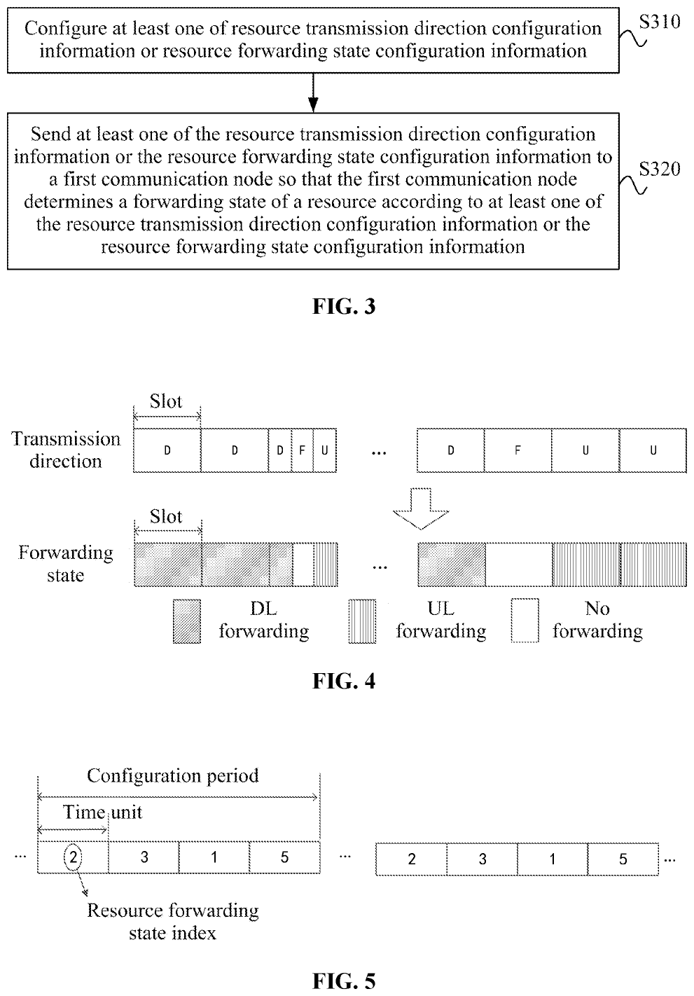

In an embodiment, FIG. 3 is a flowchart of another information determination method according to an embodiment of the present application. This embodiment may be implemented by an information determination device. The information determination device may be a second communication node. For example, the second communication node may be a base station. The base station may include one of a gNB, an eNB, a donor IAB node, an IAB node, a relay node, a TRP, an AP, a CU, a DU, or an MT. As shown in FIG. 3, this embodiment includes S310 and S320.

In S310, at least one of resource transmission direction configuration information or resource forwarding state configuration information is configured.

In S320, at least one of the resource transmission direction configuration information or the resource forwarding state configuration information is sent to a first communication node so that the first communication node determines a forwarding state of a resource according to at least one of the resource transmission direction configuration information or the resource forwarding state configuration information.

In an embodiment, that the resource transmission direction configuration information is configured includes at least one of: configuring first resource transmission direction configuration information; or configuring second resource transmission direction configuration information.

In an embodiment, the resource forwarding state configuration information includes at least one of: a resource forwarding state combination; a configuration period; at least one parameter pair composed of one time unit and one resource forwarding state; or a forwarding state bitmap; where the forwarding state bitmap is used for indicating a time unit corresponding to each resource forwarding state in the resource forwarding state combination in the configuration period.

In an embodiment, the information determination method applied by the second communication node further includes: configuring beam indication information, where the beam indication information is used for indicating a beam used by the first communication node in at least one time unit.

In an embodiment, the information determination method applied by the second communication node further includes: sending the beam indication information to the first communication node so that the first communication node determines the forwarding state of the resource according to the beam indication information.

For interpretations of the resource transmission direction configuration information, the resource forwarding state configuration information, and the beam indication information in the information determination method applied by the second communication node, reference is made to the description of the information determination method applied by the first communication node in the preceding embodiments. Details are not repeated here.

In an embodiment, that a forwarding state of a resource is determined according to resource transmission direction configuration information is described by using an example in which a first communication node is a smart repeater and a second communication node is a base station. In this embodiment, the smart repeater acquires the resource transmission direction configuration information, where the resource transmission direction configuration information provides a transmission direction of each symbol in each slot. FIG. 4 is a schematic diagram of determination of a forwarding state of a resource according to an embodiment of the present application. As shown in FIG. 4, all symbols in each of the first slot and the second slot in the resource are DL, some symbols at the beginning of the third slot are DL, some symbols in the middle of the third slot are F, and some symbols at the end of the third slot are UL. The same is true for other slots.

The smart repeater determines the forwarding state of the resource according to the transmission direction of the resource, that is, determines on which resources data amplify-and-forward is required and on which resources data amplify-and-forward is not required. For example, data amplify-and-forward is required on a symbol whose transmission direction is DL or UL, and amplify-and-forward is not required on a symbol whose transmission direction is F. In this embodiment, the smart repeater performs, on a DL symbol, amplify-and-forward on data sent by the base station to a terminal, the smart repeater performs, on an UL symbol, amplify-and-forward on data sent by the terminal to the base station, and the smart repeater does not perform amplify-and-forward on an F symbol. As shown in FIG. 4, in the first slot and the second slot, the smart repeater needs to receive data from the base station and amplify and send the data to the terminal; in the third slot, the smart repeater needs to receive data from the base station and amplify and send the data to the terminal on the first DL symbols, the smart repeater does not need to perform amplify-and-forward on the middle F symbols, and the smart repeater needs to receive data from the terminal and amplify and send the data to the base station on the last UL symbols. The same is true for other slots.

In an embodiment, the resource forwarding state configuration information includes a resource forwarding state combination. A configuration period of the configuration information may be included in the configuration information or determined by the number of elements included in the resource forwarding state combination. For example, if the resource forwarding state combination includes four elements, the configuration period is four time units. Moreover, forwarding states of resources in the configuration period are indicated, that is, the resource forwarding state configuration information periodically functions. FIG. 5 is a schematic diagram of a configuration of resource forwarding state configuration information according to an embodiment of the present application. For example, it is assumed that every M radio frames include m periods, where a starting position of every m periods is aligned with a starting position of a radio frame M1, M1 satisfies that M1 mod M=0, mod ( ) is a modulo operation, and M, M1, and n are positive integers. Alternatively, it is assumed that every two radio frames include n periods (where n is a positive integer), where a starting position of every n periods is aligned with a starting position of an even radio frame. As shown in FIG. 5, the configuration period of the forwarding state of the resource is four time units, and the resource forwarding state combination is {2, 3, 1, 5}, that is, the combination indicates forwarding states of resources in four consecutive time units. The elements in the resource forwarding state combination are the resource forwarding state indexes in Table 1. With the first time unit in the configuration period as an example, the first time unit corresponds to a resource forwarding state index 2 indicating that a forwarding state of an UL symbol is UL forwarding, and a forwarding state of a DL symbol and a forwarding state of an F symbol are no forwarding. That is, the repeater needs to perform amplify-and-forward on data on the UL symbol in the first time unit and does not need to perform amplify-and-forward on data on the DL symbol and the F symbol. Correspondingly, interpretations of other time units in the configuration period are similar.

In an embodiment, the resource forwarding state configuration information indicates forwarding states of resources in part of the time units in the period, and the configuration periodically functions. For a time unit not indicated, the forwarding state of the resource is no forwarding by default, or the forwarding state of the resource may be determined according to the transmission direction of the resource.

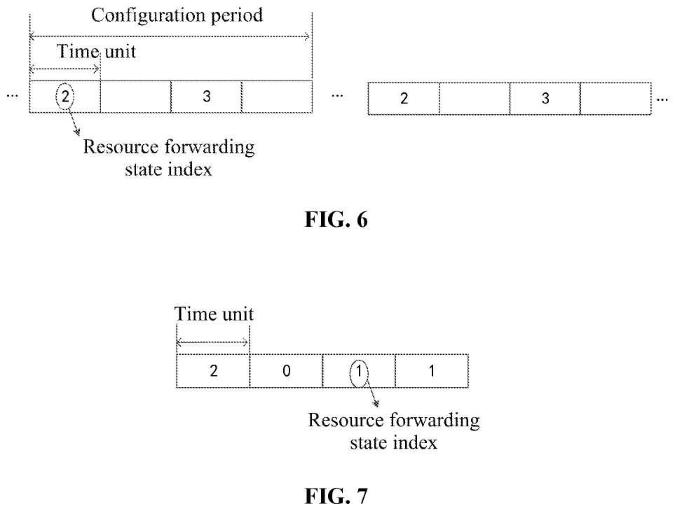

In an embodiment, the resource forwarding state configuration information may include the configuration period, a forwarding state bitmap, and the resource forwarding state combination. The forwarding state bitmap is used for indicating a time unit corresponding to each resource forwarding state in the resource forwarding state combination in the configuration period. FIG. 6 is a schematic diagram of another configuration of resource forwarding state configuration information according to an embodiment of the present application. For example, it is assumed that every two radio frames include n periods (where n is a positive integer), where the starting position of every n periods is aligned with the starting position of an even radio frame. As shown in FIG. 6, the configuration period includes four time units, the forwarding state bitmap is 1010, and the resource forwarding state combination is {2, 3}, that is, resource forwarding state indexes corresponding to the first time unit and the third time unit in each configuration period are 2 and 3 respectively. Moreover, forwarding states of resources in the second time unit and the fourth time unit in the configuration period are not indicated. For the time unit not indicated, the forwarding state of the resource is no forwarding by default, or the forwarding state of the resource may be determined according to the transmission direction of the resource.

In an embodiment, the resource forwarding state configuration information includes the configuration period and at least one parameter pair composed of {time unit index, resource forwarding state index}. For example, as shown in FIG. 6, each configuration period includes four time units, and two parameter pairs composed of {time unit index, resource forwarding state index} are included, which are {0, 2} and {2, 3} separately, that is, resource forwarding state indexes corresponding to a time unit 0 (the first time unit) and a time unit 2 (the third time unit) are 2 and 3, respectively.

In an embodiment, an information determination process is described by using an example in which a first communication node is a smart repeater and a second communication node is a base station. In this embodiment, the base station provides at least one resource forwarding state combination (that is, a resource forwarding state combination list) for the smart repeater through first resource forwarding state configuration information, one resource forwarding state combination corresponds to one resource forwarding state combination index, and an element in the resource forwarding state combination is a resource forwarding state index. Table 2 is a schematic table of a configuration of a resource forwarding state combination list according to an embodiment of the present application. As shown in Table 2, a resource forwarding state combination index 0 indicates forwarding states of resources in five time units, and the element in the resource forwarding state combination is the resource forwarding state index in Table 1, where the resource forwarding state combination index 0 corresponds to resource forwarding state indexes 0, 1, 3, 4, and 5.

TABLE 2
Configuration of the resource forwarding state combination list

| Resource Forwarding State | Resource Forwarding State |
|---|---|
| Combination Index | Combination |
| 0 | 0, 1, 3, 4, 5 |
| 1 | 1, 2, 5, 6, 2 |
| . . . | . . . |
| P | 2, 0, 1, 1 |

The base station may indicate one resource forwarding state combination index in the resource forwarding state combination list to the smart repeater through second resource forwarding state configuration information. FIG. 7 is a schematic diagram of a mapping between a resource forwarding state combination index and time units according to an embodiment of the present application. As shown in FIG. 7, the second resource forwarding state configuration information indicates a resource forwarding state combination index P, and the corresponding resource forwarding state combination is 2, 0, 1, 1, indicating forwarding states of resources in four consecutive time units.

In an embodiment, a starting time unit where the second resource forwarding state configuration information takes effect is a time unit where the second resource forwarding state configuration information is detected or the N-th time unit after the time unit where the second resource forwarding state configuration information is detected. N is a time interval for taking effect and is a positive integer greater than or equal to 1. For example, if N=3 indicates that the second resource forwarding state configuration information is detected in the n-th time unit, the second resource forwarding state configuration information starts to take effect in the (n+3)-th time unit.

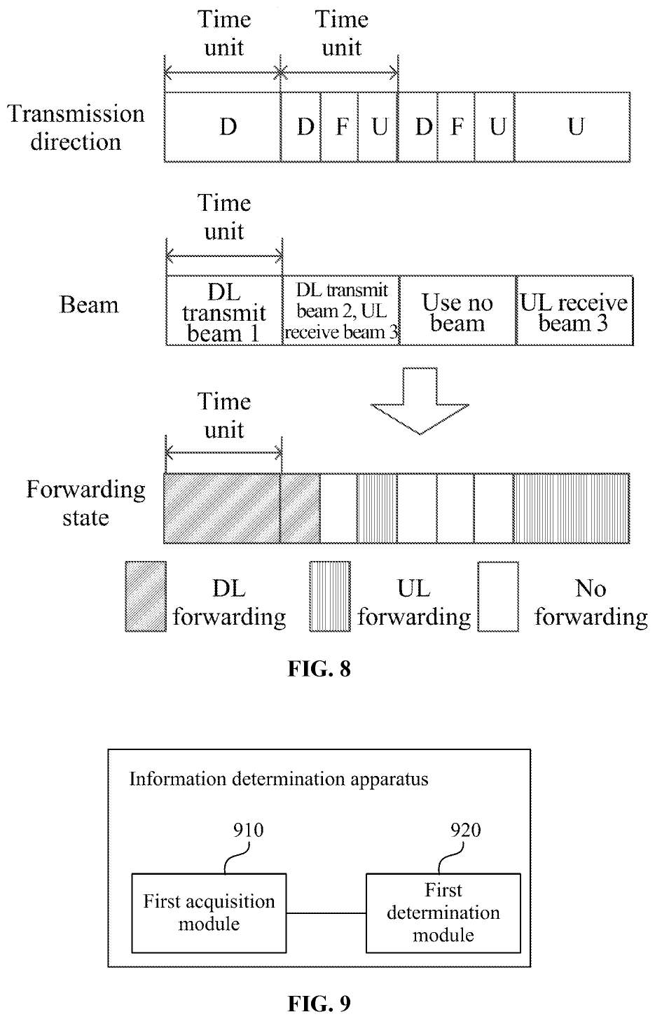

In an embodiment, a process of determining a forwarding state of a resource is described by using an example in which a first communication node is a smart repeater, a second communication node is a base station, and the forwarding state of the resource is determined according to beam indication information. FIG. 8 is another schematic diagram of determination of a forwarding state of a resource according to an embodiment of the present application. As shown in FIG. 8, in the first time unit, the smart repeater uses a DL transmit beam 1 for sending. Then, forwarding states of resources in the first time unit are DL forwarding, that is, the smart repeater needs to perform data amplify-and-forward in the time unit, that is, perform amplify-and-forward on data sent by the base station to a terminal. In the second time unit, a DL transmit beam 2 is used for sending on DL and an UL receive beam 3 is used for receiving on UL. Then, in the second time unit, a forwarding state of a DL resource is DL forwarding, a forwarding state of an UL resource is UL forwarding, and a forwarding state of an F resource is no forwarding. That is, the smart repeater needs to perform data amplify-and-forward on the DL resource and the UL resource in the time unit, where amplify-and-forward is performed on the DL resource on data sent by the base station to the terminal, and amplify-and-forward is performed on the UL resource on data sent by the terminal to the base station. No beam is indicated for the third time unit. Then, the forwarding states of the DL resource and the UL resource in the third time unit are no forwarding, that is, the smart repeater does not need to perform data amplify-and-forward on the DL resource and the UL resource in the time unit. In the fourth time unit, the UL receive beam 3 is used for receiving. Then, the forwarding state of the UL resource in the fourth time unit is UL forwarding, that is, the smart repeater needs to perform data amplify-and-forward in the time unit, where amplify-and-forward is performed on the UL resource on data sent by the terminal to the base station.

In an embodiment, FIG. 9 is a block diagram of an information determination apparatus according to an embodiment of the present application. This embodiment is applied to a first communication node. As shown in FIG. 9, this embodiment includes a first acquisition module 910 and a first determination module 920.

The first acquisition module 910 is configured to acquire at least one of resource transmission direction configuration information or resource forwarding state configuration information. The first determination module 920 is configured to determine a forwarding state of a resource according to at least one of the resource transmission direction configuration information or the resource forwarding state configuration information, where the forwarding state includes at least one of DL forwarding, UL forwarding, or no forwarding.

In an embodiment, the resource transmission direction configuration information includes at least one of first resource transmission direction configuration information or second resource transmission direction configuration information.

In an embodiment, for a time resource, a transmission direction provided in the second resource transmission direction configuration information covers any transmission direction provided in the first resource transmission direction configuration information; or for a time resource, a transmission direction provided in the second resource transmission direction configuration information covers an F transmission direction provided in the first resource transmission direction configuration information.

In an embodiment, for the time resource, in the case where at least two pieces of second resource transmission direction configuration information provide transmission directions of the time resource, a transmission direction of the time resource is determined in one of the manners below.

For the time resource, the at least two pieces of second resource transmission direction configuration information provide the same transmission direction; for the time resource, a transmission direction provided in latest second resource transmission direction configuration information prevails; or for the time resource, a transmission direction provided in earliest second resource transmission direction configuration information prevails.

In an embodiment, the first determination module 920 is configured to determine one of the following: a forwarding state of a resource whose transmission direction is DL is the DL forwarding, a forwarding state of a resource whose transmission direction is UL is the UL forwarding, and a forwarding state of a resource whose transmission direction is F is no forwarding; a forwarding state of a resource whose transmission direction is DL is the DL forwarding, a forwarding state of a resource whose transmission direction is UL is the UL forwarding, in the case where the first communication node is scheduled to receive on a resource whose transmission direction is F, a forwarding state of the resource whose transmission direction is F is the DL forwarding, in the case where the first communication node is scheduled to send on the resource whose transmission direction is F, the forwarding state of the resource whose transmission direction is F is the UL forwarding, and in the case where the first communication node is not scheduled on the resource whose transmission direction is F, the forwarding state of the resource whose transmission direction is F is no forwarding; a forwarding state of a resource whose transmission direction is DL is the DL forwarding, a forwarding state of a resource whose transmission direction is UL is the UL forwarding, in the case where the first communication node is indicated a transmit beam used on a resource whose transmission direction is F, a forwarding state of the resource whose transmission direction is F is the DL forwarding, in the case where the first communication node is indicated a receive beam used on the resource whose transmission direction is F, the forwarding state of the resource whose transmission direction is F is the UL forwarding, and in the case where a beam indicated to the first communication node for use on the resource whose transmission direction is F is null or the first communication node is not indicated a beam used on the resource whose transmission direction is F, the forwarding state of the resource whose transmission direction is F is no forwarding; or, a forwarding state of a resource whose transmission direction is DL is the DL forwarding, a forwarding state of a resource whose transmission direction is UL is the UL forwarding, in the case where the first communication node is scheduled to receive or indicated a transmit beam used on a resource whose transmission direction is F, a forwarding state of the resource whose transmission direction is F is the DL forwarding, in the case where the first communication node is scheduled to send or indicated a receive beam used on the resource whose transmission direction is F, the forwarding state of the resource whose transmission direction is F is the UL forwarding, and in the case where the first communication node is not scheduled, and a beam indicated to the first communication node for use on the resource whose transmission direction is F is null or the first communication node is not indicated a beam used on the resource whose transmission direction is F, the forwarding state of the resource whose transmission direction is F is no forwarding.

In an embodiment, the resource forwarding state configuration information indicates a forwarding state of a resource in at least one time unit.

In an embodiment, the resource forwarding state configuration information includes at least one of: a resource forwarding state combination; a configuration period; at least one parameter pair composed of one time unit and one resource forwarding state; or a forwarding state bitmap; where the forwarding state bitmap is used for indicating a time unit corresponding to each resource forwarding state in the resource forwarding state combination in the configuration period.

In an embodiment, the resource forwarding state configuration information includes first resource forwarding state configuration information and second resource forwarding state configuration information; where the first resource forwarding state configuration information includes at least a resource forwarding state combination list, the resource forwarding state combination list includes at least one resource forwarding state combination, and one resource forwarding state combination corresponds to one resource forwarding state combination index; and the second resource forwarding state configuration information is used for indicating one resource forwarding state combination index in the resource forwarding state combination list.

In an embodiment, the resource forwarding state combination index is used for indicating the forwarding state of the resource in the at least one time unit.

In an embodiment, an element in the resource forwarding state combination is used for indicating a forwarding state of a resource in a corresponding time unit.

In an embodiment, in a time unit where no resource forwarding state is provided, the forwarding state of the resource is determined according to a resource transmission direction in the time unit or determined according to a beam indicated for use in the time unit.

In an embodiment, a starting time unit where the second resource forwarding state configuration information takes effect includes one of: a time unit where the second resource forwarding state configuration information is detected or an N-th time unit after a time unit where the second resource forwarding state configuration information is detected, where N is a positive integer greater than or equal to 1.

In an embodiment, the information determination apparatus applied to the first communication node further includes a second acquisition module.

The second acquisition module is configured to acquire beam indication information, where the beam indication information is used for indicating a beam used by the first communication node in at least one time unit.

In an embodiment, for a time unit, the beam indication information includes at least one of: a beam used on a DL resource; a beam used on an UL resource; a transmit beam or a receive beam used on an F resource; a transmit beam used on a first group of resources; a receive beam used on a second group of resources; or a null beam used.

In an embodiment, the information determination apparatus applied to the first communication node further includes a second determination module.

The second determination module is configured to determine the forwarding state of the resource according to the beam indication information, which includes one of the following: in the case where a transmit beam used on a resource in a time unit is indicated or a beam used on a DL resource in a time unit is indicated, a forwarding state of the resource is the DL forwarding; in the case where a receive beam used on a resource in the time unit is indicated or a beam used on an UL resource in the time unit is indicated, a forwarding state of the resource is the UL forwarding; or in the case where a bean indicated for use on the resource in the time unit is null or no beam is indicated for use on the resource in the time unit, a forwarding state of the resource is no forwarding.

In an embodiment, a forwarding state of the F resource is determined in at least one of the following manners: the forwarding state of the F resource is no forwarding by default; the forwarding state of the F resource is determined according to the beam indication information; or the forwarding state of the F resource is determined according to scheduling of the first communication node by a second communication node on the F resource.

The information determination apparatus provided in this embodiment is configured to implement the information determination method applied by the first communication node in the embodiment shown in FIG. 2 and has similar implementation principles and technical effects, which are not repeated here.

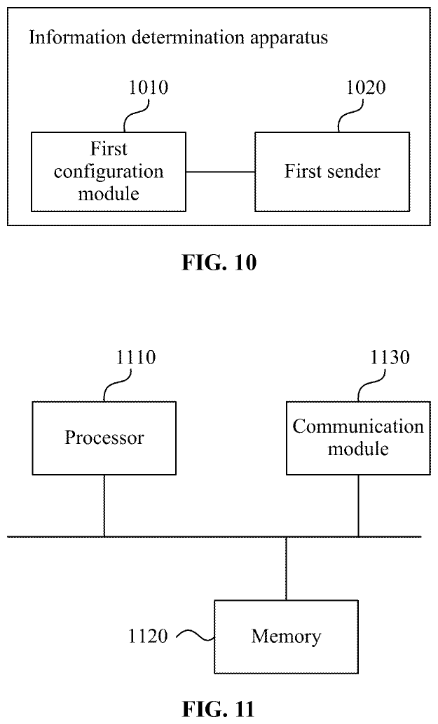

In an embodiment, FIG. 10 is a block diagram of another information determination apparatus according to an embodiment of the present application. This embodiment is applied to a second communication node. As shown in FIG. 10, this embodiment includes a first configuration module 1010 and a first sender 1020.

The first configuration module 1010 is configured to configure at least one of resource transmission direction configuration information or resource forwarding state configuration information. The first sender 1020 is configured to send at least one of the resource transmission direction configuration information or the resource forwarding state configuration information to a first communication node so that the first communication node determines a forwarding state of a resource according to at least one of the resource transmission direction configuration information or the resource forwarding state configuration information.

In an embodiment, the first configuration module 1010 includes at least one of the following:

First resource transmission direction configuration information is configured; or second resource transmission direction configuration information is configured.

In an embodiment, the resource forwarding state configuration information includes at least one of: a resource forwarding state combination; a configuration period; at least one parameter pair composed of one time unit and one resource forwarding state; or a forwarding state bitmap; where the forwarding state bitmap is used for indicating a time unit corresponding to each resource forwarding state in the resource forwarding state combination in the configuration period.

In an embodiment, the information determination apparatus applied to the second communication node further includes a second configuration module.

The second configuration module is configured to configure beam indication information, where the beam indication information is used for indicating a beam used by the first communication node in at least one time unit.

In an embodiment, the information determination apparatus applied to the second communication node further includes a second sender.

The second sender is configured to send the beam indication information to the first communication node so that the first communication node determines the forwarding state of the resource according to the beam indication information.

The information determination apparatus provided in this embodiment is configured to implement the information determination method applied by the second communication node in the embodiment shown in FIG. 3 and has similar implementation principles and technical effects, which are not repeated here.

In an embodiment, FIG. 11 is a structure diagram of a communication device according to an embodiment of the present application. As shown in FIG. 11, the device provided in the present application includes a processor 1110, a memory 1120, and a communication module 1130. One or more processors 1110 may be provided in the device, with one processor 1110 shown as an example in FIG. 11. One or more memories 1120 may be provided in the device, with one memory 1120 shown as an example in FIG. 11. The processor 1110, the memory 1120, and the communication module 1130 in the device may be connected via a bus or in other manners. FIG. 10 shows the connection via a bus as an example. In this embodiment, the device may be a first communication node. For example, the first communication node may be a smart repeater.

As a computer-readable storage medium, the memory 1120 may be configured to store software programs, computer-executable programs, and modules, such as program instructions/modules (for example, the first acquisition module 910 and the first determination module 920 in the information determination apparatus) corresponding to the device according to any embodiment of the present application. The memory 1120 may include a program storage region and a data storage region, where the program storage region may store an operating system and an application program required by at least one function, and the data storage region may store data created depending on the use of the device. Additionally, the memory 1120 may include a high-speed random-access memory and may also include a nonvolatile memory, such as at least one magnetic disk memory, a flash memory, or another nonvolatile solid-state memory. In some examples, the memory 1120 may include memories remotely disposed relative to the processor 1110, and these remote memories may be connected to the device via a network. Examples of the preceding network include, but are not limited to, the Internet, an intranet, a local area network, a mobile communication network, and a combination thereof.

The communication module 1130 is configured to perform communication interaction between the first communication mode, a second communication node, a third communication node, and a core network.

In the case where an information determination device is the first communication node, the preceding device may be configured to perform the information determination method applied by the first communication node in any one of the preceding embodiments and has corresponding functions and effects.

In the case where the information determination device is the second communication node, the preceding device may be configured to perform the information determination method applied by the second communication node in any one of the preceding embodiments and has corresponding functions and effects.

Embodiments of the present application further provide a storage medium including a computer-executable instruction, where the computer-executable instruction, when executed by a processor in a computer, is used for performing an information determination method applied by a first communication node. The method includes: acquiring at least one of resource transmission direction configuration information or resource forwarding state configuration information; and determining a forwarding state of a resource according to at least one of the resource transmission direction configuration information or the resource forwarding state configuration information, where the forwarding state includes at least one of DL forwarding, UL forwarding, or no forwarding.

Embodiments of the present application further provide a storage medium including a computer-executable instruction, where the computer-executable instruction, when executed by a processor in a computer, is used for performing an information determination method applied by a second communication node. The method includes: configuring at least one of resource transmission direction configuration information or resource forwarding state configuration information; and sending at least one of the resource transmission direction configuration information or the resource forwarding state configuration information to a first communication node so that the first communication node determines a forwarding state of a resource according to at least one of the resource transmission direction configuration information or the resource forwarding state configuration information.

It is to be understood by those skilled in the art that the term user equipment covers any suitable type of wireless user equipment, for example, a mobile phone, a portable data processing apparatus, a portable web browser, or a vehicle-mounted mobile station.

Generally speaking, embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program steps, may represent interconnected logic circuits, modules, and functions, or may represent a combination of program steps and logic circuits, modules, and functions. Computer programs may be stored in a memory. The memory may be of any type suitable for a local technical environment and may be implemented using any suitable data storage technology, such as, but not limited to, a read-only memory (ROM), a random-access memory (RAM), or an optical memory device and system (for example, a digital video disc (DVD) or a compact disc (CD)). Computer-readable media may include non-transitory storage media. The data processor may be of any type suitable for the local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on a multi-core processor architecture.

In all the embodiments of the present application, the forwarding state may be a switch state. The switch state includes an on state and an off state. The method for determining the forwarding state of the resource in the preceding embodiments can be used for determining the switch state of the resource as long as the DL forwarding and the UL forwarding in the embodiments are replaced with the on state, no forwarding in the embodiments is replaced with the off state, the DL forwarding and the UL forwarding in the drawings and the table are also replaced with the on state, no forwarding in the drawings and the table is also replaced with the off state, and the time unit sets corresponding to the DL forwarding and the UL forwarding in the resource forwarding state configuration information are combined into a time unit set corresponding to the on state. For example, the resource forwarding state configuration information includes a configuration period and a set of time units with the on state in the configuration period. A forwarding state of a time unit not configured is the off state by default. For a resource with the off state, the first communication node performs no forwarding operation on the resource. For a resource with the on state, the DL forwarding or the UL forwarding is determined according to the transmission direction of the resource. For example, on a DL resource with the on state, the first communication node performs amplify-and-forward on data sent by the second communication node to the third communication node, and on an UL resource with the on state. the first communication node performs amplify-and-forward on data sent by the third communication node to the second communication node.

1. An information determination method, the method being applied by a first communication node and comprising:
acquiring resource transmission direction configuration information and beam indication information, wherein the beam indication information is used for indicating a beam used by the first communication node in at least one time unit; and
determining a forwarding state of a resource according to the resource transmission direction configuration information and the beam indication information, wherein the forwarding state comprises at least one of downlink (DL) forwarding, uplink (UL) forwarding, or no forwarding.

2-13. (canceled)

14. The method of claim 1, wherein for a time unit, the beam indication information comprises at least one of: a beam used on a DL resource; a beam used on an UL resource.

15. The method of claim 1, wherein
determining the forwarding state of the resource comprises one of the following:
in a case where a beam used on a DL resource in the time unit is indicated, a forwarding state of the resource is the DL forwarding;
in a case where a beam used on an UL resource in the time unit is indicated, a forwarding state of the resource is the UL forwarding; or
in a case where no beam is indicated for use on the resource in the time unit, a forwarding state of the resource is no forwarding.

16. The method of claim 1, wherein a forwarding state of an F resource is determined in the following manner:
the forwarding state of the F resource is no forwarding.

17. An information determination method, the method being applied by a second communication node and comprising:
configuring resource transmission direction configuration information and beam indication information, wherein the beam indication information is used for indicating a beam used by the first communication node in at least one time unit; and
sending the resource transmission direction configuration information and the beam indication information to a first communication node so that the first communication node determines a forwarding state of a resource according to the resource transmission direction configuration information and the beam indication information.

18-21. (canceled)

22. A communication device, comprising a communication module, a memory, and at least one processor, wherein
the communication module is configured to perform communication interaction between a first communication node, a second communication node, a third communication node, and a core network;
the memory is configured to store at least one program; and
when executed by the at least one processor, the at least one program causes the at least one processor to perform the information determination method of claim 1.

23. A non-transitory storage medium, which is configured to store a computer program, wherein the computer program, when executed by a processor, causes the processor to perform the information determination method of claim 1.

24. The method of claim 1, wherein the DL forwarding refers to that the first communication node performs amplify-and-forward on data sent by a second communication node to a user equipment (UE), the UL forwarding refers to that the first communication node performs amplify-and-forward on data sent by the UE to the second communication node, and no forwarding refers to that the first communication node performs no forwarding operation.

25. The method of claim 17, wherein for a time unit, the beam indication information comprises at least one of: a beam used on a DL resource; a beam used on an UL resource.

26. A communication device, comprising a communication module, a memory, and at least one processor, wherein
the communication module is configured to perform communication interaction between a first communication node, a second communication node, a third communication node, and a core network;
the memory is configured to store at least one program; and
when executed by the at least one processor, the at least one program causes the at least one processor to perform the information determination method of claim 14.

27. A communication device, comprising a communication module, a memory, and at least one processor, wherein
the communication module is configured to perform communication interaction between a first communication node, a second communication node, a third communication node, and a core network;
the memory is configured to store at least one program; and
when executed by the at least one processor, the at least one program causes the at least one processor to perform the information determination method of claim 15.

28. A communication device, comprising a communication module, a memory, and at least one processor, wherein
the communication module is configured to perform communication interaction between a first communication node, a second communication node, a third communication node, and a core network;
the memory is configured to store at least one program; and
when executed by the at least one processor, the at least one program causes the at least one processor to perform the information determination method of claim 16.

29. A communication device, comprising a communication module, a memory, and at least one processor, wherein
the communication module is configured to perform communication interaction between a first communication node, a second communication node, a third communication node, and a core network;
the memory is configured to store at least one program; and
when executed by the at least one processor, the at least one program causes the at least one processor to perform the information determination method of claim 17.

30. A communication device, comprising a communication module, a memory, and at least one processor, wherein
the communication module is configured to perform communication interaction between a first communication node, a second communication node, a third communication node, and a core network;
the memory is configured to store at least one program; and
when executed by the at least one processor, the at least one program causes the at least one processor to perform the information determination method of claim 24.

31. A communication device, comprising a communication module, a memory, and at least one processor, wherein
the communication module is configured to perform communication interaction between a first communication node, a second communication node, a third communication node, and a core network;
the memory is configured to store at least one program; and
when executed by the at least one processor, the at least one program causes the at least one processor to perform the information determination method of claim 25.

32. A non-transitory storage medium, which is configured to store a computer program, wherein the computer program, when executed by a processor, causes the processor to perform the information determination method of claim 14.

33. A non-transitory storage medium, which is configured to store a computer program, wherein the computer program, when executed by a processor, causes the processor to perform the information determination method of claim 15.

34. A non-transitory storage medium, which is configured to store a computer program, wherein the computer program, when executed by a processor, causes the processor to perform the information determination method of claim 16.

35. A non-transitory storage medium, which is configured to store a computer program, wherein the computer program, when executed by a processor, causes the processor to perform the information determination method of claim 17.

36. A non-transitory storage medium, which is configured to store a computer program, wherein the computer program, when executed by a processor, causes the processor to perform the information determination method of claim 24.
